(19) United States
(12) Patent Application Publication
(10) Pub. No.: US 2016/0063429 A1
(43) Pub. Date: Mar. 3, 2016

(54) APPARATUS AND METHOD FOR PERFORMING AN ITEM PICKING PROCESS

(71) Applicant: SYMBOL TECHNOLOGIES, INC., Schaumburg, IL (US)

(72) Inventors: Jordan K. Varley, Mississauga (CA); Jaeho Choi, Whitestone, NY (US); Mark Thomas Fountain, Earlsfield (GB)

(21) Appl. No.: 14/471,197

(22) Filed: Aug. 28, 2014

(51) Int. Cl. G06Q 10/08

(52) U.S. Cl. CPC G06Q 10/087

(57) ABSTRACT

A method and system for performing an item picking process is provided. In operation, a computing device receives an indication of a known item to be picked. The computing device also receives a known set of signature information for the known item from a first information source. As well, data is received from a first module, at least a portion of the first module being wearable. A detected set of signature information for at least one item being picked up is detected based on the data received and item attributes are identified for the at least one item being picked up based on the known and the detected sets of signature information.

### BACKGROUND OF THE INVENTION

Item picking, such as picking items to fulfil an order at a warehouse, is a labor intensive process that involves many steps. For example, the person picking the item must first identify the location of the item. Once the location is identified, such as a specific set of shelves, the person must then determine which of the objects, such as boxes, located on the shelf are appropriate to pick.

Data capture devices such as bar code scanners facilitate the picking process. For example, a bar code scanner may be used to read bar codes on shelves to locate the items. Moreover, a data capture device is typically used to read markers such as barcodes on the boxes to identify the appropriate boxes. This process is highly inefficient, involving interruptions to the workflow. For example, the item picker must pick up a data capture device, scan the box to determine the box's identity, put down the data capture device, pick up the box, put the box down on a cart, and pick up the data capture device again to continue with the next box. Moreover, the process is highly error prone. For example, there is no mechanism by which to detect whether a box is wrongly marked, or what the box may contain if the marker is missing. Accordingly, there is a need for an improved system and method for performing a picking process.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a picking system in accordance with some embodiments.

FIG. 2 is a block diagram of a device for use in the picking system of FIG. 1 in accordance with some embodiments.

FIG. 3 illustrates an example shelf containing boxes for use with the picking system of FIG. 1 in accordance with some embodiments.

FIG. 4 is a flowchart of a method of picking objects in accordance with some embodiments.

FIG. 5 illustrates a portion of the picking system of FIG. 1 in use in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

A method and system for performing an item picking process is provided. In operation, a computing device receives an indication of a known item to be picked. The computing device also receives a known set of signature information for the known item from a first information source. As well, data is received from a first module, at least a portion of the first module being wearable. A detected set of signature information for at least one item being picked up is detected based on the data received and item attributes are identified for the at least one item being picked up based on the known and the detected sets of signature information.

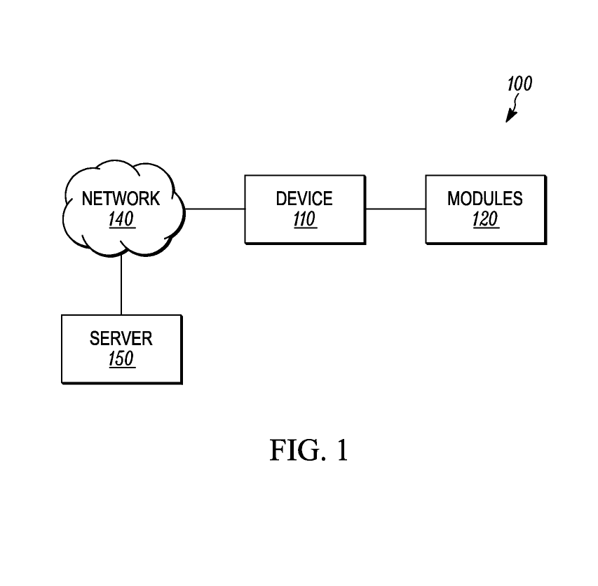

FIG. 1 is a block diagram of a picking system 100 in which methods and components required for performing processes associated with item picking is implemented in accordance with the embodiments. The picking system 100 includes a device 110, typically a computing device, in communication with one or more modules 120 for detecting various operational and environmental conditions. The device 110 is also in communications, through the network 140, with an additional computing device, in this example a server 150.

The picking system 100 may take various forms. In some implementations, at least portions of the picking system 100 may be wearable by an operator of the picking system 100. In one non-limiting example, at least some of the modules 120, or their portions, as well as device 110 may be located on various parts of an operator's body or clothing. For example, in one implementation, the device 110 may be a mobile device carried by an operator, and some of the modules 120, or portions thereof, may be located on the operator's hand or hands, arms, chest or legs. In variations, one or more of the modules 120, or portions thereof, may be included on or integrated with various clothing items. For example, some or portions of the modules 120 may be included in or on gloves worn by the operator. In further variations, one or more of the modules 120, or portions thereof, may be integrated with the device 110. In yet further variations, the device 110 may be a static device located in a room or a vehicle, for example, and apart from the operator of the picking system 100. In such variations, the device 110 may remain in communication with the modules 120 as appropriate. In other variations, device 110, implemented in any form including wearable, may perform the functionality of the server 150.

The device 110 may be any computing device capable of communicating with and processing data from the modules 120. The device 110 may take form of, but is not limited to, wearable devices such as body or head mounted devices, vehicle mounted devices, handheld devices such as a smartphone, a tablet, a bar code scanner, optical code reader and the like, a data capture terminal connected to a handheld device, a desktop, a vehicle mounted device, a laptop or notebook computer, an automated teller machine, a kiosk, a vending machine, a payment machine, facsimile machine, a point of sale device, a vehicle mounted device and the like. Embodiments may be advantageously implemented to perform item picks using the picking system 100.

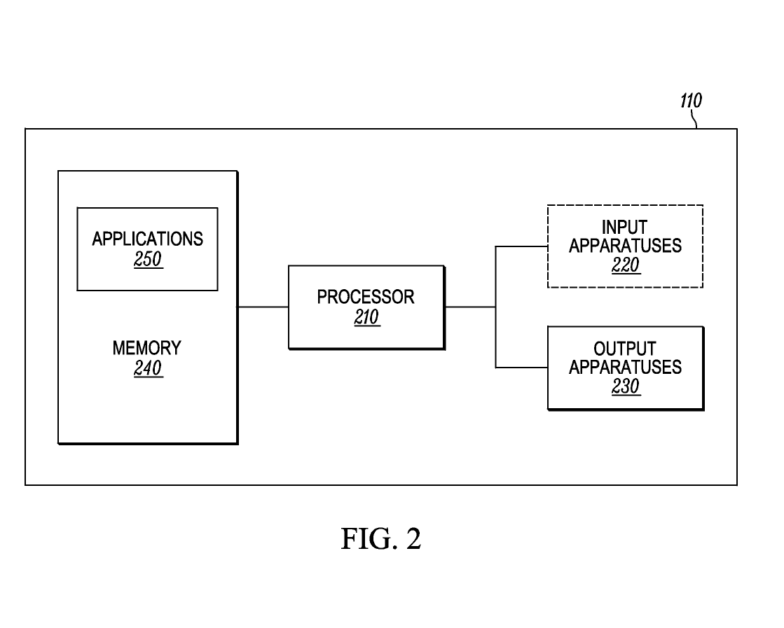

Referring to FIG. 2, the device 110 comprises a processor 210, one or more optional input apparatuses 220, output apparatuses 230 and memory 240. The processor 210 runs or executes operating instructions or applications that are stored in the memory 240 to perform various functions for the device 110 and to process data. The processor 210 includes one or more microprocessors, microcontrollers, digital signal processors (DSP), state machines, logic circuitry, or any device or devices that process information based on operational or programming instructions stored in the memory 240. In accordance with the embodiments, the processor 210 processes various functions and data associated with carrying out a process of item picks.

The optional input apparatuses 220 are any apparatuses which allow the picking system 100 to receive input from an operator. For example, the input apparatuses 220 may be a keyboard, a touch pad, a touch component of a display, a microphone, sensors for detecting gestures, buttons, switches or other apparatuses which may be used to receive operator input. In variations, combinations of such apparatuses may be used.

The output apparatuses 230 are any apparatuses capable of providing feedback to an operator. Accordingly, the output apparatuses 230 may be in the form of, for example, an audio apparatus, such as a speaker, a haptic device such as a vibrator, or a visual apparatus such as a display or a light emitting diode (LED), or a combination of such apparatuses.

The memory 240 is any apparatus or non-transitory medium capable of storing digital information. Accordingly, the memory 240 may be an IC (integrated circuit) memory chip containing any form of RAM (random-access memory) or ROM (read-only memory), a CD-RW (compact disk with read write), a hard disk drive, a DVD-RW (digital versatile disc with read write), a flash memory card, external subscriber identity module (SIM) card or any other non-transitory medium for storing digital information. The memory 240 comprises applications 250. The applications 250 include various software and/or firmware programs necessary for the operation of the picking system 100 as well as software and/or firmware programs (e.g. warehouse management, email applications etc.) that address specific requirements of the operator.

Referring back to FIG. 1, communications between the device 110 and the modules 120 may take a wired or wireless form. In accordance with some implementations, it will be appreciated that the communications may utilize a wireless communication system, a wired communication system, a broadcast communication system, or any other equivalent communication system. For example, the wireless communication system may function utilizing any wireless radio frequency channel, for example, a one or two-way messaging channel, or a mobile radio channel. Similarly, it will be appreciated that the wireless communication system may function utilizing other types of communication channels such as Institute of Electrical and Electronics Engineers (IEEE) 802.11 (Wi-Fi™), IEEE 802.16 and/or Bluetooth™ channels.

In further implementations, it will be appreciated that the communication between the device 110 and the modules 120 may function utilizing a wireline communication channel such as a direct wire connection. The direct wire connection, for example may be to a port on the device 110, such as a serial port such as universal serial bus (USB), a serial port, a parallel port, a Thunderbolt™ port, an Ethernet port or other equivalent communications ports.

In other implementations, the communications between the modules 120 and the device 110 may be optical or sound based. In yet other implementations, the electrical signals comprising the communications may be conducted through the body, such as the skin, of an operator.

Further, it will be appreciated that the communication between the device 110 and the modules 120 may, in some variations, utilize the network 140 (such connections are not shown). The network 140 may be any communications network such as a local area network (LAN) or a wide area network (WAN) or a combination. The LAN, for example, may employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures to enable the communication among the devices and/or the modules. The WAN, for example, may use a physical network media such as X.25, Frame Relay, ISDN, Modem dial-up or other media to connect devices or other local area networks.

In the following description, the term “communication system” or “connection” or “communication” refers to any of the systems mentioned above or an equivalent. Embodiments may be advantageously implemented to perform item picking processes on the picking system 100.

Continuing with FIG. 1, the device 110 may be in communication with one or more additional computing devices, such as the server 150. The server 150 is any computing device capable of communicating with the device 110 to send and receive data, as well as process such data. The server 150 may take the form of, but is not limited to, wearable devices such as body or head mounted devices, vehicle mounted devices, handheld devices such as a smartphone, a tablet, a bar code scanner, optical code reader and the like, a data capture terminal connected to a handheld device, a desktop, a vehicle mounted device, a laptop or notebook computer, an automated teller machine, a kiosk, a vending machine, a payment machine, facsimile machine, a point of sale device, a vehicle mounted device and the like. Embodiments may be advantageously implemented to perform item picking using the picking system 100.

In some implementations, the server 150 may assist with the performance of the item picking system 100's functions. For example, as explained in greater detail below, in some variations, the server 150 may assist with identifying locations for the picking system 100, such as the location of its operator in a warehouse or the relative location of the picking system 100's components with respect to each other. In variations, the server 150 may maintain one or more databases, or similar data storage constructs. In such variations, the server 150 may provide information from the databases to the device 110 and update the databases based on information received from the device 110. For example, the server 150 may maintain a warehouse database, providing information related to items to be picked by the picking system 100, such as the known location and size or dimension of the items, and updating the databases based on information received from the device 110, such as how many items were picked by the picking system 100. In variations, device 110 may perform some or all of the functions of the server 150.

Communications between the device 110 and the server 150 may take a wired or wireless form and may occur through network 140, in a similar manner to the communications between the modules 120 and device 110 as described above.

The modules 120 include one or more components such as transmitters, indicators or sensors for providing data regarding different operational and environmental conditions. In some implementations, the modules 120 may include modules for identifying location. The location identified may correspond to the location of an operator of the picking system 100 (macro location). Alternatively, the location identified may correspond to the location of the components of the modules 120 in relation to each other (micro location). For example, identifying a macro location may enable identifying the location of an operator of the picking system 100 in a warehouse, whereas identifying a micro location may allow identifying the relative locations of the operator's hands (or gloves worn over the hands).

The location identifying modules 120 may take any form suitable for identifying macro and micro locations. For example, the location identifying modules 120 may include wearable optical reflectors that are placed on one or more body parts or clothing such as hands or gloves of an operator. One or more cameras, also part of the location identifying modules 120 may be used to detect the optical markers or reflectors. For example, cameras may be located throughout a warehouse and may be accessible by the device 110 or the server 150. Alternatively, one or more cameras may be worn by the operator, or may be integrated into the device 110 in a wearable form. The images provided by the cameras may be used by the server 150 or the device 110 to identify the macro location of an operator, as well as the micro location of the components. In some variations, the cameras may be used to obtain location information without the use of reflectors. For example, object recognition methods may be used to identify an operator and/or body parts such as hands, to determine macro and micro locations for the operator. In variations, visual tags may be used to determine macro location. For example, tags may include numbers and may be placed at appropriate locations in the warehouse making them accessible to body worn cameras, for example. The tag numbers may be used by the device 110 or the server 150 to decode the macro location.

In variations, location identifying modules 120 may comprise one or more wearable transmitters located on the body or clothing of an operator, including the device 110. Accordingly, one or more suitable receivers, such as Wi-Fi™ receivers or Bluetooth™ receivers accessible by either the server 150 or the device 110 or both may be used to detect the transmitter signals and identify a macro and/or a micro location. For example, in some implementations, the server 150 or device 110 may identify the macro location of an operator based on a triangulation of the Wi-Fi™ signals received by Wi-Fi™ access points. In other examples, micro-location of each Bluetooth™ transmitter, placed, for example on the gloves, may be identified based on the signal strengths of the signals received by one or more receivers, also located on the body. In some variations, at least some of the receivers may be integrated with the device 110.

In other examples, the transmitters may be part of an ultrasonic location identifying apparatus. Accordingly, the modules 120 may comprise wearable tags attached to the body or the clothing of an operator (e.g. hands, wrists or gloves) which may transmit an ultrasound signal such as a chirp. Microphone sensors placed elsewhere on the body or clothing may identify the micro location of the tags based on the ultrasound signals received from the tags. In some implementations, the microphone sensors may be integrated with the device 110, or may be located away from the body of the operator. In further variations, location identifying modules may at least in part be located on a cart, on loading bay doors, inside a trailer, in specific locations of specific areas or rooms, such as chillers or on a fork lift truck, for example.

The modules 120 may also include components for receiving item signature information. Each item may be an article (such as a muffler), a container containing articles (such as a box of mufflers), or a container containing containers containing articles (such as a box containing bottles of pills). An article may be anything that the picking system 100 is typically used for picking for various item management purposes such as shipping, transfer and other similar purposes.

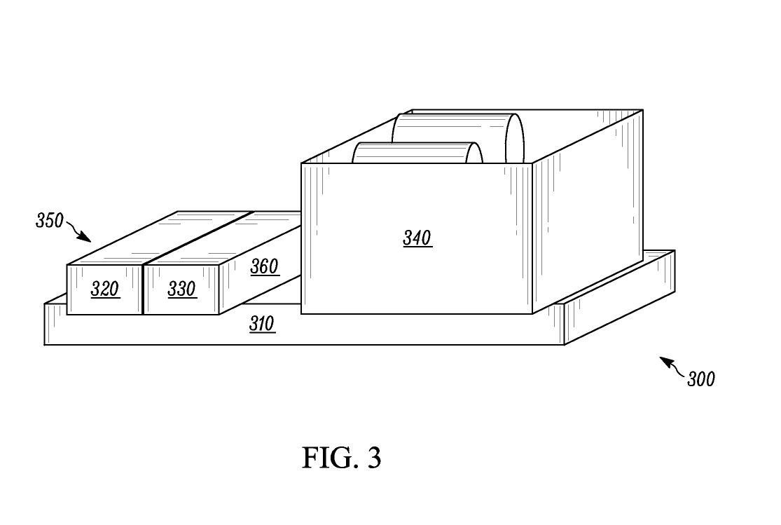

Each item may be identified on the basis of signature information. The signature information is attributes or characteristics of the item that may be detected or obtained and may include, color, weight, dimensions and date (such as the date the item was placed in the warehouse). To further illustrate item signature information, FIG. 3 shows an example warehouse shelf at 300, loaded with various boxes (items) containing mufflers (articles). In accordance with this non-limiting example, individual muffler boxes 320 and 330 have signature information comprising weight of 5 lbs, color of white, and a horizontal dimension, along the front face 310 of the shelf 300, of 1 linear foot. A multi-muffler box 340 contains an unknown number of mufflers, has an unknown weight, and has a horizontal dimension, along the face 310 of the shelf 300, of 5 linear feet. A multi-muffler box 340, for example, may be an open box into which unboxed mufflers, such as customer returns, are deposited as a “catchall” container.

Signature information already known about an item may be obtained from various sources of information. For example, signature information regarding certain items may be provided as part of requesting an operator of the picking device 100 to pick those items. Alternatively, or in addition, signature information for an item may also be requested and obtained, for example, from the databases maintained by the server 150.

In some implementations, modules 120 for receiving item signature information may be used to obtain signature information for the item from the item itself. Accordingly, the item itself may act as an additional information source. For example, an item may include associated markers containing signature information for the item. Markers may take various forms, including text, images, barcodes or radio frequency identification (RFID) tags placed on (or in, where appropriate) the items. For example, in the illustrative example, an RFID tag (not shown) on the example individual muffler box 320 may include the box 320's weight, and the number of articles contained in the box 320, as well as the manufacturer of the articles. Scanning such markers may therefore allow obtaining item based signature information for the item.

In variations, known signature information from the databases may also be obtained on the basis of the item based signature information obtained from the modules 120. For example, an item identifier or a name obtained from an item's marker may be provided to the databases and known item signature information may be received from the databases in return.

The modules 120 for receiving item based signature information may take any form suitable for receiving signature information for items. For example, they may be wearable data sensors such as an optical sensor including a charge-coupled device (CCD) sensor, a laser scanner and the like, that may capture data from optical data sources such as bar codes, quick response (QR) codes and video response (VR) codes, printed text and images and other similar optical data sources. Data sensors may also include touch sensitive capacitive coupling technologies such as Bodycom™ where the sensors may read a code by touching that code. Data sensors may also include electromagnetic sensors such as near field communication (NFC) sensors and RFID readers that may capture data from electromagnetic data sources, such as from RFID tags and NFC tags, in or on the objects. In accordance with some implementations, the modules 120 may include multiple data sensors.

To capture data, the sensors of the modules 120 for receiving item based signature information may be placed at or near the data source, such as a bar code, at an appropriate distance. For example, to capture RFID or NFC based data, antennae associated with the RFID reader or NFC sensor are brought within a prescribed range of the item containing the RFID or NFC tag.

The modules 120 may also include components for detecting item signature information. Specifically, such components may be used to detect item characteristics which form part of an item's signature, as opposed to receiving coded information included on an item's marker, for example. Thus, the modules 120 for detecting item signature information may be used to detect an item's weight, dimension, color and others.

The modules 120 for detecting item signature information may take any form suitable for detecting item characteristics. For example, sensors may be used to detect object weight. Accordingly, the modules 120 may include wearable force sensors or electromyography (EMG) sensors. As an example, the force sensors may be included in gloves. The indicators received from the force sensors may be used to estimate the weight of the object picked up using gloves having force sensors. In other variations, EMG sensors for detecting muscle activity, such as activity in the bicep or flexor muscles, may be included on the arms of the operator. Accordingly, the muscle activity detected may be used to estimate weight of an object being picked up by an operator. The sensors may be calibrated for each individual. Moreover, the calibration may be ongoing, as information for each item picked is detected and validated. For example, when an operator picks up a 5 lbs box and confirms the weight as correct, the sensor data for that item may be used as calibration data for that sensor to reflect the confirmed detection.

In some variations detected, known and item based signature information may be used to identify further attributes regarding the items picked. The item attributes are typically information not available at information sources such as markers and databases. They may include information missing, such as the number of articles in a box, or information not obtainable from the information sources, such as how many boxes were picked up by the operator at once.

For example, missing or unknown signature information for an item may be completed on the basis of the detected and item based signature information. In some implementations, for example, individual article weight may be known, but the number of articles in a box may not be known. For example, multi-muffler box 340, of FIG. 3 is one such item, where a number of individual mufflers may have been deposited in an open container box. Accordingly, the sources of signature information, such as the warehouse database, or the markers on the multi-muffler box 340 may not have any information on the number of mufflers in the box, but may only identify it as a box containing mufflers. In alternative examples, a box may have no markers, and thus an operator may not know what known item it may correspond to.

Picking up a box with an unknown number of articles may allow the picking system 100 to detect the weight of the box through modules 120 such as force sensors or EMG sensors, for example. Accordingly, in cases where the item marker is missing, the box may also be identified as belonging to one of known types of items. Dividing the box weight, by individual article weight may allow a determination of a number of items in the multi-muffler box 340 as a derived signature information. For example, if each muffler is determined to weigh 4.8 lbs based on information received from the warehouse database, and the weight of the box is determined to be 49 lbs based on data received from the EMG sensors, the number of mufflers contained by the multi-muffler box 340 is estimated to be ten. In other implementations, detected item dimension may be the basis on which the number of articles contained by an item are identified. For example, if each article is known to be 1 linear feet, and the item (a box for example), is detected to be 5 linear feet, than the number of articles contained by that item may be identified to be 5.

Another item attribute that may be identified based on the detected, known and item based signature information may be the number of items picked. For example, the picking system 100 may determine the number of items picked based on a detected weight or a dimension, or both, of the items picked. As an example, referring to FIG. 3, an operator may pick up both boxes 320 and 330 at once, by squeezing the two boxes together from the sides 350 and 360. Picking up the two boxes may allow the picking system 100 to detect the weight of the boxes through force sensors or EMG sensors, for example. Dividing the detected weight, by individual item weight, as received from the database or one of the markers for the boxes, may allow a determination of the number of boxes picked. For example, if each muffler box contains individual mufflers is known to weigh 5 lbs, based on information received from the warehouse database, and the weight of the boxes picked up is detected to be 10 lbs based on data received from the EMG sensors, the number of individual muffler boxes pick up may be identified as two.

In variations, the number of items picked may be identified on the basis of detected dimension. For example, ultrasound tags may indicate that the two hands picking up the boxes 320 and 330 are two linear feet apart. When the linear dimension of an individual box is known to be 1 linear feet, horizontally, then the picking system 100 may identify that two boxes are picked up. In some variations, different methods of deriving signature information may be used simultaneously, to confirm the derived signature information. For example, weight and dimension may be used simultaneously to derive the number of boxes picked up, and the derived numbers compared to determine whether they agree. When they do, operations may continue uninterrupted. When they do not, an error state may be entered and the operator may be provided with an indication of error through one of the output apparatuses 230, for example, requesting manual intervention.

In further variations, the number of items picked up may be determined on the basis of a number of markers that can be detected by the modules 120. Referring back to the example of FIG. 3, after the operator picks up the two boxes 320 and 330, RFID readers on the operators hand may indicate detecting 2 RFID tags. Accordingly, it may be determined that two boxes are being picked up. In variations, strength of the signal received by the modules 120 may be used to distinguish tags associated with items being picked up and those that are left on the shelf 300, such as the multi-muffler box 340 in FIG. 3.

In some implementations, the signature information obtained from different sources such as the databases and markers as well as signature information detected on the basis of the modules 120 and any attributes identified may be compared to perform error checking. For example, if the detected weight of a box does not match that obtained from a database, or the markers on that box, an error state may be entered. Alternatively, if the detected weights, detected on the basis of data from different components of the modules 120 do not match, an error state may once again be entered.

Additional error checking may also be performed on the basis of signature information. For example, where the items being picked are perishable, the items that have been in the warehouse longest may be desirable to be picked first. If the date of the currently picked item, as determined on the basis of the markers on the item, for example, is not the oldest as determined based on the information contained in the database, an error state may once again be entered.

In an error state, an error indication may be provided to the operator through one or more of the output apparatuses 230 of the device 110, and manual intervention may be requested. Once an error state is entered, an operator may take different actions. For example, the operator may ignore the error, may resolve any conflict in the information manually, or return the picked up item or items back to the shelves.

The modules 120 may also include components for identifying motion. For example, motion sensors such as accelerometers and gyroscopes may detect acceleration and changes in orientation respectively. Accordingly, the accelerometers or gyroscopes may be included on the hands, arms or gloves, for example, allowing the tracking the motion of a picked item, from the shelf to a cart. In some implementations, for example, a plurality of accelerometers may be placed on parts of an operator's body so as to enable measuring motion along an associated plurality of axes. In accordance with such an arrangement, the motion of the body parts, and hence the object may be detected. The plurality of accelerometers, for example, may comprise three accelerometers placed along perpendicular axes to provide for three dimensional motion detection.

Some of the location identifying and the signature information detecting modules 120 discussed above may also be utilized as the modules 120 for identifying motion. For example, the location identifying modules 120 may be used to track motion by determining location periodically in time. As a further example, EMG sensors may also be utilized as motion identifying modules 120, by identifying appropriate muscle activity associated with movement of the body parts such as arms or hands.

In operation, the use of the picking system 100 may reduce interruptions during picking, leading to a more efficient item pick process. For example, the use of the picking system 100 may allow information acquisition regarding an item to occur as a continuous or near continuous part of an operator's movements for locating and picking an object. Accordingly, interruptions brought on by processes specific to obtaining information, such as reaching for a handheld scanner to scan the object, may be reduced.

Moreover, the use of the picking system 100 may increase the flexibility of item picking operations. For example, the detected signature information for an item or items picked up may allow picking multiple items at once or items with unknown quantities of articles.

In addition, the accuracy of the picking operation and the picking system 100 may also be increased. For example, by continuously comparing, during the picking motion, object information obtained and identified on the basis of the different modules 120, errors may be detected and resolved by updating information, for example, during the process of picking an item.

Finally, the management of known information, such as warehouse databases, can also be performed more efficiently, since the database can be updated, for example on the basis of the number of articles or items picked, as part of an operator's continuous or near continuous movements while performing the picking.

Referring back to FIG. 2. the applications 250 contained in memory 240 includes instructions that may be executed by processor 210 to enable the operation of the picking system 100. For example, based on the instructions, the device 110 may receive, from various modules 120 as well as the server 150, data relating to the operational and environmental conditions. For example, the processor 210 may select which of the modules 120 to obtain data from, based on the operational and environmental conditions. Moreover, the operational and the environmental conditions may be altered based on the operations of the picking system 100.

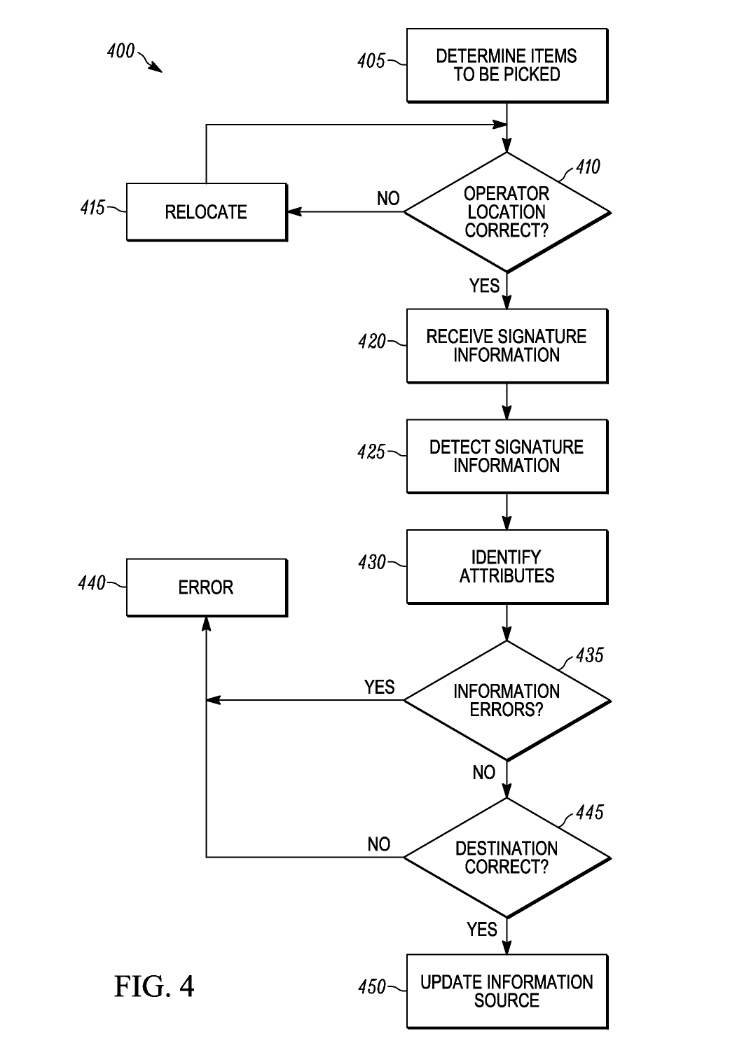

FIG. 4 represents a flowchart of a method 400 for performing an object pick with the picking system 100 of FIG. 1 in accordance with some embodiments. As a simplified illustrative example, the components of the modules 120, or parts thereof, are taken to be included as part of gloves worn by an operator as well as on the arms of the operator.

As shown in FIG. 4, the method 400 begins by determining the items to be picked at block 405. This information may be provided to the device 110, either manually through the input apparatuses 220, or automatically, for example as part of a workflow by the server 150, in the form of a request.

The determination of the items to be picked triggers the operational state where the macro location of the operator is confirmed as being near the items as indicated at 410. In this state, the device 110 may receive data from the location identifying modules 120 to determine macro location information, and verify it against known location information form the item indicated by information sources such as a warehouse database. The warehouse database information may be provided by the server 150 for example. In variations, the device 110 may obtain the location confirmation from the server 150. In such variations, the server 150 may determine the macro location of the operator based on images obtained from cameras that are, for example, installed in a warehouse or based on location scans made by the operator using a scanner. If the operator is not near the mufflers, the operator is instructed to relocate at block 415.

Once the operator is within the vicinity of the items, which in this illustrative example is the vicinity of the shelf 300 of FIG. 3, the picking system 100 receives item based signature information regarding the item being picked up at block 420. Specifically, item based signature information regarding the item may be obtained throughout the process of picking the object. Accordingly, the device 110 may receive item based signature information from one or more of the modules 120 at any stage of picking the object. For example, in some implementations, as the operator of the picking system 100 brings her hands to the object to pick the object up, item based signature information may be obtained from RFID readers embedded in the gloves as the gloves are brought within a threshold of the item (or a shelf where the markers are placed on the shelf for example). Alternatively, or in addition, when the operator's gloves touch the item, Bodycom™ sensors embedded in the gloves may be used to obtain item based signature information.

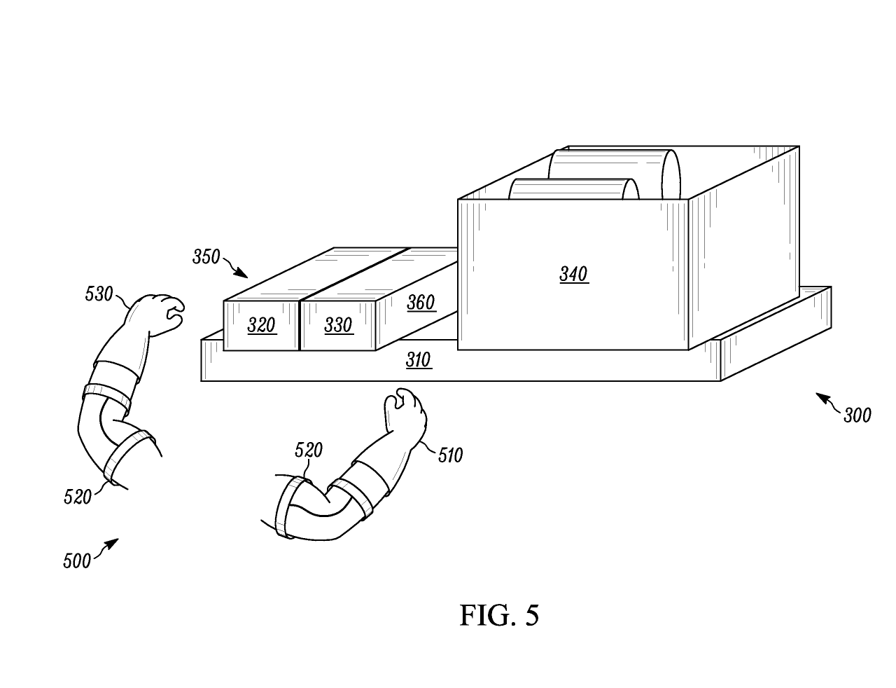

In this illustrative example, as indicated at FIG. 5, as the operator 500 brings her hands up to the boxes 320 and 330 in order to pick those boxes, an RFID reader (not shown) embedded into the glove 510 receive data from the RFID tag (not shown) embedded in the box 330. In this example, the received data includes a unique item identifier, the type of article contained (muffler), the number of articles in the box 330 (one), and the dimension of the box (one foot linear horizontal).

The device 110 may also obtain item signature information from other sources, such as the warehouse database maintained by the server 150. For example, the device 110 may send the unique item identifier, received on the basis of the RFID scan of the item, to the server 150 and receive, in return, known signature information for that item. In variations, the database information may have already been provided to the device 110 when the item to be picked was determined on the basis of a request from the server 150 for example, or as part of the manual entry of the item pick request.

The item picking system 100 also detects item signature information on the basis of one or more of the modules 120 for detecting detected item signature information as indicated at 425 of FIG. 4. For example, the device 110 may receive images from one or more wearable cameras on the operator and determine a box color on the basis of the obtained image. Furthermore, when the object is actually picked up, additional information such as weight and dimension may be obtained on the basis of received data from additional modules 120. For example, weight may be detected on the basis of received data from force sensors or EMG sensors. Dimension may be detected, on the other hand, based on data received from the location identifying modules 120. For example data received from ultrasound tags may allow determining how far apart the hands picking the object are, which may in turn be used as an indication of item dimension.

Referring back to FIG. 5, in this illustrative example, picked up item weight is determined to be 10 lbs based on the data provided by the EMG sensors 520 worn on the arms of the operator. Moreover, the linear horizontal spacing between the gloves of the operator is determined to be 2 feet based on ultrasound tags (not shown) located on the gloves 510 and 530 of the operator.

Continuing with method 400, at 430 the picking system 100 identifies additional attributes of the picked up items as appropriate. For example, the picking system 100 may attempt to derive missing signature information based on the known, item-based and detected information. In one implementation, for example, when the number of articles in the picked up item is not known on the basis of different information sources, the number may be derived based on the detected box weight and known article weight, as described above. Alternatively, additional signature information may be identified for the item or items being pick up to resolve information mismatch. For example, in this illustrative example the item dimension is determined to be 2 linear feet horizontally and the item weight as 10 lbs. However, the warehouse database or the marker information cannot identify such an item. Accordingly, the number of items picked up may be determined to be 2 boxes containing one muffler each, based on the known weight and dimension information for a given box containing a single muffler.

Continuing with method 400, at block 435, received and detected signature information as well as any attributes identified are compared to determine any information errors, such as mismatch of information obtained from different sources that cannot be resolved. For example, the signature information obtained from the RFID tags may be compared to the database information. Moreover, the RFID tag information may also be compared with the detected signature information and identified attributes. As an example of an unresolved error, the database may indicate that an item contains 10 articles. However, on the basis of the detected weight, the picking system may estimate the number of articles in that item to be 5.

When unresolved information errors are detected, the picking system 100 enters an error state as indicated at 440. In an error state, an error indication may be provided to the operator through one or more of the output apparatuses 230 of the device 110, and manual intervention may be requested. Once an error state is entered, an operator may take different actions. For example, the operator may ignore the error, may resolve any conflict in the information manually (using for example the input apparatuses 220), or return the picked up item or items back to the shelves.

When no errors are detected, at 445 the destination of the picked up item or items are confirmed. For example, data from motion tracking components may be used to determine that the picked up items are placed on a cart, or an appropriate compartment of a cart, as opposed to back to shelf 300, or the wrong compartment of the cart. The destination may be specified in various ways. For example, the destination may be received at the time the item to be picked are determined at 405. When the detected destination does not match the specified destination, the picking system 100 may enter the error state 440.

Once the picked up items are confirmed to be placed in their specified destination, such as a cart, one or more of the information sources may be updated to reflect that the item has been picked as indicated at 450. For example, the warehouse database may be updated to reflect the number of items or articles picked. When the number of items picked are less than the requested number of items to be picked, the method 400 may be repeated, as many times as necessary, to achieve the picking of the specified number of items.

In variations of method 400, the determination of which modules 120 to use at what time point in the item picking process may be manual, the operator providing triggers for obtaining data from one or more of the modules 120 at different time points. The triggers may be provided through, for example, input apparatuses 220. Alternatively, the determination may be automatic, for example based on predetermined sequence of triggers supplied as part of a workflow. As an example, the first component to be monitored may be the RFID reader. Obtaining object information from the RFID reader may subsequently trigger the EMG sensors to be monitored until the data received from the EMG sensors indicates a weight for the object. The determination of weight may then trigger monitoring the location identifiers to obtain a dimension for the object. As it may be appreciated, the predetermined trigger sequence may be varied as appropriate for the picking tasks as well as the type of modules 120 included in the picking system 100.

In further variations of method 400, the order of signature information received and the detection of information errors may differ. For example, in some implementations, attributes may not be identified prior to any determination of information error, and instead may be used as a way to resolve any identified information errors. As a further example, the derived signature information may be used to confirm information obtained from markers on the picked item, prior to comparing any information obtained from a database for example.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of performing an item picking process at a picking system comprising:
receiving an indication of a known item to be picked;
receiving a known set of signature information for the known item from a first information source;
receiving data from a first module, at least a portion of the first module being wearable;
detecting a detected set of signature information for at least one item being picked up based on the data; and
identifying item attributes for the at least one item being picked up based on the known and the detected sets of signature information.

2. The method of claim 1 wherein the first module further comprises at least one of a wearable camera, a wearable ultrasound location mechanism, a wearable transmitter, a wearable force sensor and a wearable EMG sensor.

3. The method of claim 2 wherein the detected set of signature information further comprises at least one of detected color, detected weight and detected dimension.

4. The method of claim 3 wherein the detected dimension is based on a relative micro location of at least some components of the first module.

5. The method of claim 4 wherein the at least some components are integrated with gloves and the relative micro location is a distance between the gloves.

6. The method of claim 1
wherein the known set of signature information includes at least one of a known article weight and a known article dimension,
wherein the detected set of signature information includes at least one of a detected item weight and a detected item dimension,
wherein the item attributes further comprise the number of articles being picked up and wherein the identifying further comprises:
identifying the number of articles being picked up based on at least one of
the detected item weight and the known article weight and
the detected item dimension and the known article dimension.

7. The method of claim 6 further comprising:
updating the first information source based on the identified number of articles being picked up.

8. The method of claim 1
wherein the known set of signature information includes at least one of a known item weight and a known item dimension,
wherein the detected set of signature information includes at least one of a detected item weight and a detected item dimension,
wherein the item attributes further comprises the number of items being picked up and wherein the identifying further comprises:
identifying the number of items being picked up based on at least one of:
the known item weight and the detected item weight and
the known item dimension and the detected item dimension.

9. The method of claim 1 wherein the first information source is a database, the method further comprising:
identifying missing information from the database based on at least one of the detected set of information and the item attributes;
updating the database with the missing information.

10. The method of claim 1, further comprising:
detecting errors based on the known and the detected sets of signature information and the item attributes.

11. The method of claim 1 the method further comprising:
receiving an item-based set of signature information for the item being picked up from a second module.

12. The method of claim 11 wherein the second module comprises at least one of an imaging sensor, a radio frequency identification (RFID) reader, an near field communication (NFC) reader or a touch sensitive capacitive coupling reader.

13. The method of claim 11 wherein the item-based set of signature information is obtained from a marker associated with the item being picked up.

14. The method of claim 1 the method further comprising:
receiving a plurality of item-based set of signature information for the item being picked up from a second module,
wherein the item attributes further comprises the number of items being picked up and wherein the identifying further comprises:
identifying the number of items being picked up based on the plurality of item-based set of signature information.

15. The method of claim 1 further comprising:
receiving motion data from a third module comprising at least one of an accelerometer, gyroscope and location identifying modules; and
confirming the destination placement of the item being picked up based on the additional data.

16. The method of claim 15 wherein the motion data corresponds to a motion of the item being picked up during the picking process.

17. The method of claim 15 further comprising:
when the destination placement is confirmed, updating the first information source based on the detected set of signature information and the item attributes.

18. The method of claim 1 wherein the indication of the known item includes an item location, the method further comprising:
determining a macro location based on the data; and
verifying the macro location against the item location.

19. A picking system comprising:
a first module having a wearable portion; and
a computing device in communication with the first module, the computing device having a processor operating to:
receive an indication of a known item to be picked;
receive a known set of signature information for the known item from a first information source;
receive data from a first module, at least a portion of the first module being wearable;
detect a detected set of signature information for an item being picked up based on the data; and
identify item attributes for the item being picked up based on the known and the detected sets of signature information.

20. The device of claim 19 wherein the wearable portion of the first module is attached to at least one of one hand, two hands, one arm, two arms, one glove, two gloves, a t-shirt and a head.
